(19) United States
(12) Patent Application Publication
(10) Pub. No.: US 2009/0256924 A1
(43) Pub. Date: Oct. 15, 2009

(54) IMAGE CAPTURE DEVICE CAPABLE OF COMBINING IMAGES AND PRINT METHOD THEREOF

(75) Inventors: Liu-Pin Lee, Tu-Cheng (TW); Wei-Jen Wang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/261,017

(22) Filed: Oct. 29, 2008

(30) Foreign Application Priority Data
Apr. 9, 2008 (CN) 200810300931.8

(51) Int. Cl. H04N 5/228

(52) U.S. Cl. 348/222.1; 348/207.99

(57) ABSTRACT

An image capturing device includes a storage unit storing a plurality of images and a library of electronic print frames, and a selection unit providing selection of one of the electronic print frames and corresponding images. The selected images are transformed from their original format into a transition format which enables them to be scaled. The scaled images are arranged on the selected electronic print frame to provide a combination image.

### BACKGROUND

1. Technical Field

The disclosure relates to image capture and, particularly, to an image capture device capable of combining images and a print method thereof.

2. Description of the Related Art

Many currently available digital cameras provide a direct connection to a printer, allowing convenient printing of images without requiring the involvement of a computer or other additional processing means. In such an arrangement, however, the printer typically can print only one image at a time. Users may, however, wish for multiple images to be printed on a single sheet. This task must normally be accomplished, as before, via the aid of a computer or other additional processing means, for example, using image editing software installed on a computer.

Therefore, it is desirable to provide an image capture device capable of combining images and a print method thereof, which can overcome the limitations described.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the image capture device and print method. Moreover, in the drawings, like reference numerals designate corresponding parts throughout the several views.

FIG. 1 is a functional block diagram of an image capture device of the disclosure including a display unit, in accordance with one embodiment.

FIG. 2 is a schematic view of the display unit of FIG. 1.

FIG. 3 is another schematic view of the display unit of FIG. 1.

FIG. 4 shows an exemplary selection display of the image capture device of FIG. 1.

FIG. 5 shows an exemplary menu display of the image capture device of FIG. 1.

FIG. 6 shows another exemplary menu display of the image capture device of FIG. 1.

FIG. 7 is another view of the display unit of FIG. 1.

FIG. 8 is a flowchart of a print method of the image capture device of FIG. 1, in accordance with one embodiment.

### DETAILED DESCRIPTION OF THE EMBODIMENTS

Embodiments of the image capture device and print method thereof will now be described in detail with reference to the drawings.

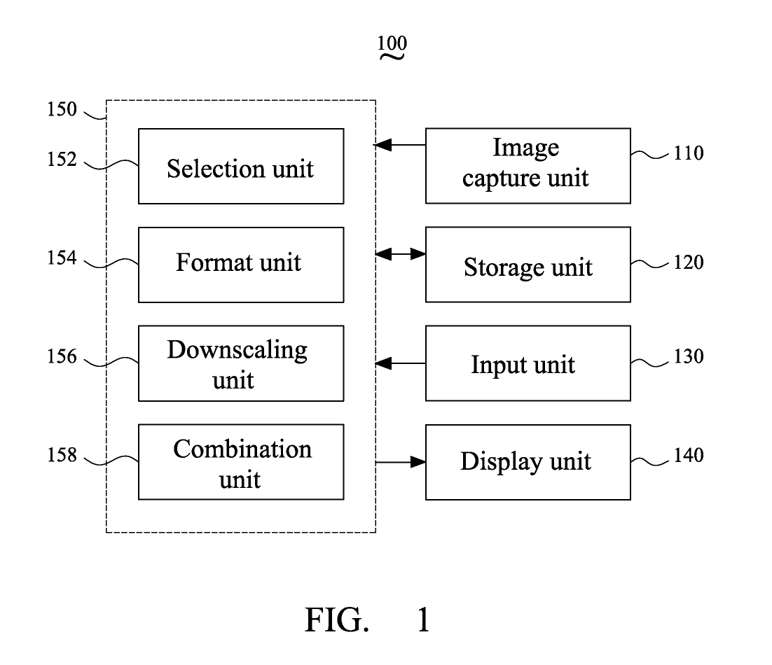

Referring to FIG. 1, the image capture device 100 includes an image capture unit 110, a storage unit 120, an input unit 130, a display unit 140, and a combination system 150. In this embodiment, the image capture device 100 is a digital still camera, although any other image capture device such as a cellular phone having a camera module is equally applicable while remaining well within the scope of the disclosure. The image capture unit 110 is configured for capturing a plurality of images. The image capture unit 110 may include a Charge Coupled Device (CCD).

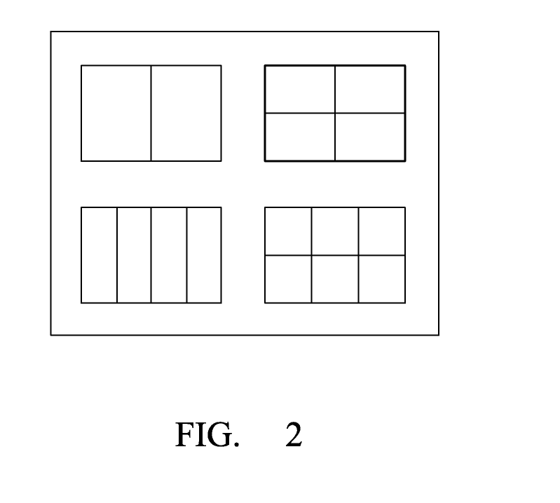

The storage unit 120, such as a removable memory card or a static random access memory (SRAM), is configured for storing the images and a library of electronic print frames. In this embodiment, the electronic print frames are preset by the manufacturer, but can, alternatively, be set by user. Each electronic print frame has a unique layout and can frame a predetermined number of images in a corresponding layout. In this embodiment, the electronic print frames include four layouts: 1×2, 2×2, 1×4, 2×3 (see FIG. 2), but the electronic print frames are not limited thereto.

The input unit 130 is configured for receiving user input designating selection from among the electronic print frames. The display unit 140, such as a liquid crystal display (LCD), is configured for displaying a variety of views in response to user selection (shown in FIGS. 2-7). In other embodiments, the input unit 130 and the display unit 140 can be integrated into a touch panel.

The combination system 150 includes a selection unit 152, a format unit 154, a downscaling unit 156 and a combination unit 158.

The selection unit 152 provides selection of one of the electronic print frames and a corresponding number of images. Referring to FIG. 2, in operation, the electronic print frames stored in the storage unit 120 are displayed on the display unit 140 and one of the 2×2 electronic print frame, as an example here, is selected (see FIG. 2). While the 2×2 electronic print frame is shown here to be composed of four rectangular sub-frames arranged in 2 lines and 2 columns, it should be understood that the layout is not limited thereto, and alternative layouts are well within the scope of the disclosure. For example, star-shaped sub-frames or heart-shaped sub-frames can be used instead of or in addition to the rectangular sub-frames disclosed here.

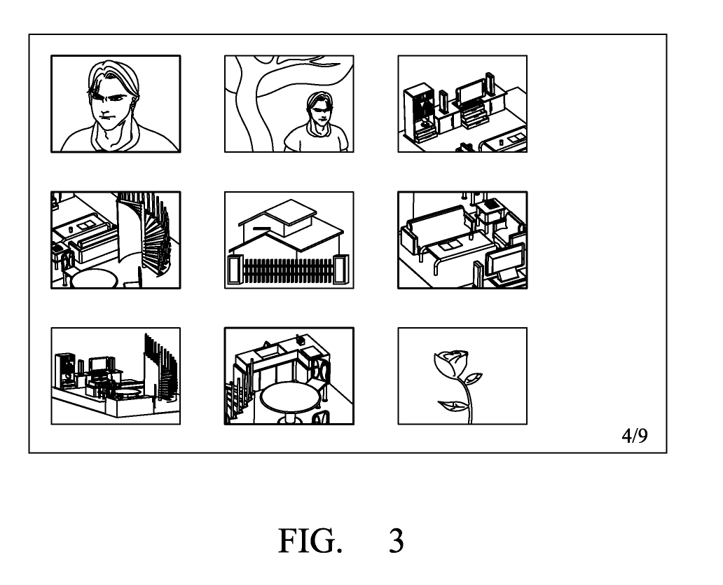

As shown in FIG. 3, the captured images are displayed on the display unit 140, from which images to be applied in the selected layout can be chosen.

The format unit 154 is configured for transforming the selected images from their original format into a transition format which enables necessary processing. Here, the original format is Joint Photographic Experts Group (JPEG) format. The transition format is YCrCb format, where Y represents the luminance component of the image, and Cb and Cr represent the blue-difference and red-difference chrominance components of the image, respectively.

The downscaling unit 156 is configured for scaling the transformed images.

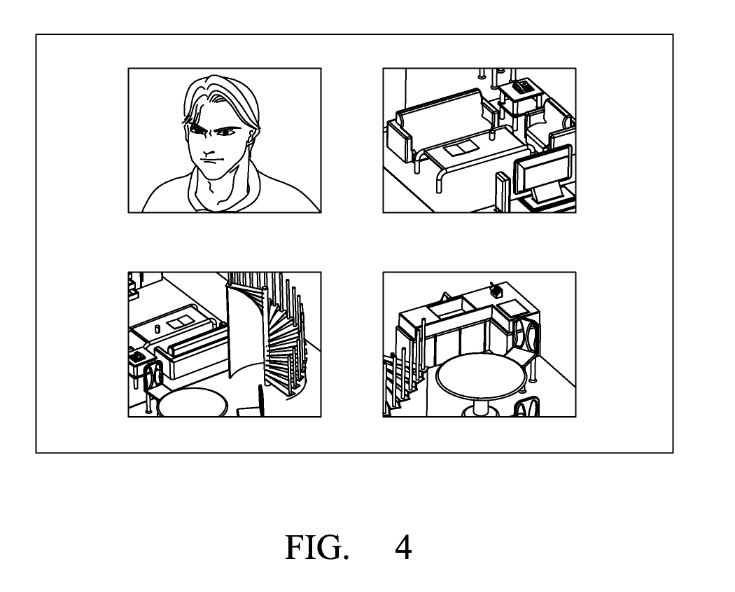

The combination unit 158 is configured for arranging the scaled images to the selected electronic print frame and transforming into the original format to form a combined image (see FIG. 4). Here, the format is JPEG

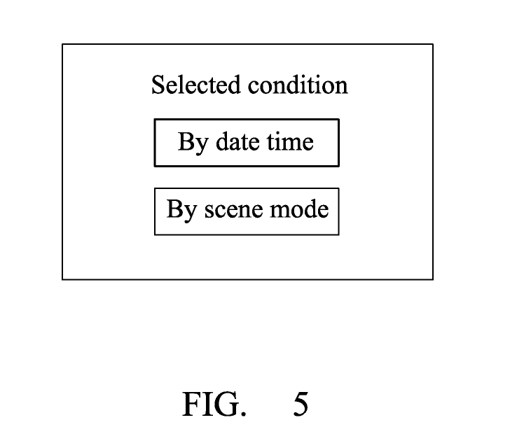

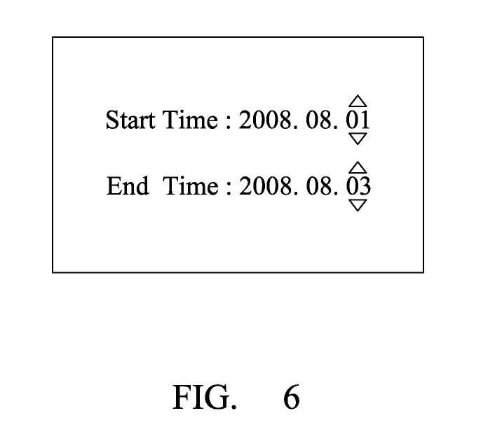

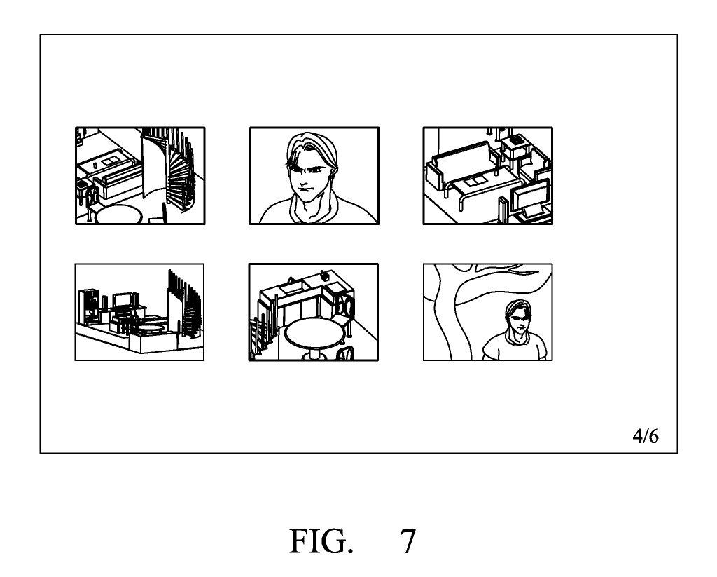

Referring to FIGS. 5 through 7, the selection unit 152 provides selection of images in response to selective query input. For example, once the electronic printing frame is determined, a menu offering one or more query options is generated on display unit 140. For example, as shown, the options can include “By date time” or “By scene mode” (see FIG. 5) search types. Subsequent query menus can be generated allowing input of query parameters, such as, here, start and end times (see FIG. 6). Images matching the parameters, such as, in the example, those with timestamps of 2008.08.01-2008.08.03, are retrieved and displayed. In the example, six corresponding images are accessed from the storage unit 120 and displayed on the display unit 140 (see FIG. 7). Four desired images are further selected from the six images to populate the selected four-image electronic printing frame. The selected images are transformed from their original format into a transition format which enables the selected images to be scaled.

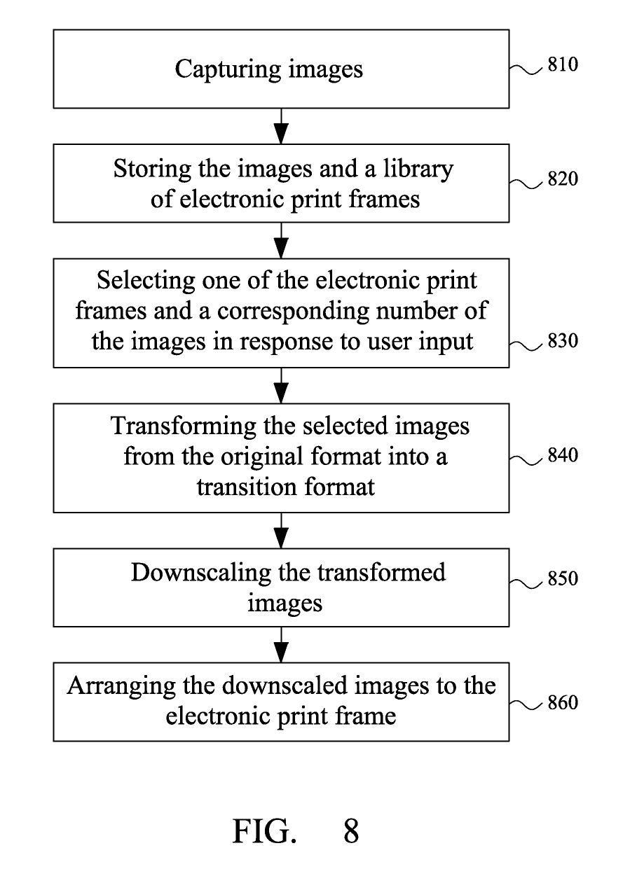

FIG. 8 shows an embodiment of a print method performed by the image capture device 100.

In step 810, images are captured by an image capture unit 110. The image capture unit 110 may be a Charge Coupled Device (CCD).

In step 820, the captured images are stored, here, by a storage unit 120. The storage unit 120 is a removable memory card or a static random access memory (SRAM) with a library of electronic print frames pre-stored thereon. In this embodiment, the electronic print frames are preset by the manufacturer, but can, alternatively, be set by a user. Each electronic print frame has a unique layout and thereby can frame a predetermined number of images in corresponding distribution. While here, the electronic print frames include four layouts: 1×2, 2×2, 1×4, 2×3 (see FIG. 2), the library is not limited thereto.

In step 830, one of the electronic print frames and a corresponding number of captured images are selected in response to user input. The electronic print frames stored in the storage unit 120 are displayed on the display unit 140 and one, such as, here, the 2×2 electronic print frame, is selected (see FIG. 2).

In step 840, the selected images are transformed from the original format into a transition format which enables the selected images to be scaled. In this embodiment, the original format is Joint Photographic Experts Group (JPEG) format. The transition format is YCrCb format, where Y represents the luminance component of the image, and Cb and Cr represent the blue-difference and red-difference chrominance components of the image, respectively.

In step 850, the four transformed images are downscaled.

In step 860, the downscaled images are arranged into the electronic print frame.

The image capture device 100 generates a combination of images, conveniently and with a wide variety of possible layout options, with no need of additional processing means such as a computer or other device.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. An image capturing device comprising:
a storage unit capable of storing a plurality of images and a plurality of electronic print frames, each electronic print frame capable of framing a predetermined number of the images in a unique layout;
a selection unit capable of selecting one of the plurality of electronic print frames and a corresponding number of the plurality of images in response to user input:
a format unit capable of transforming the selected images from an original format to a transition format which enables the selected images to be scaled;
a scaling unit configured for scaling the transformed images; and
a combination unit capable of arranging the scaled images to the selected electronic print frame to generate a combined image.

2. The image capture device of claim 1, wherein the storage unit is a removable memory card or a static random access memory.

3. The image capture device of claim 1, further comprising an input unit configured for providing selection capability, and a display unit configured for displaying images and electronic print frames.

4. The image capture device of claim 3, wherein the input unit and the display unit are integrated into a touch panel.

5. The image capture device of claim 1, wherein the transition format is YCrCb format, where Y represents the luminance component of the image, and Cb and Cr represent the blue-difference and red-difference chrominance components of the image, respectively.

6. The image capture device of claim 3, wherein the display unit is further configured for displaying various selection views.

7. The image capture device of claim 3, wherein the display unit is a liquid crystal display.

8. The image capture device of claim 1, wherein the plurality of electronic print frames have geometrical shapes.

9. A method of an image capture device capable of combining images, comprising:
selecting an electronic print frame and images to be combined;
transforming the selected images from their original format into a transition format;
scaling the transformed images; and
populating the selected electronic print frame with the scaled images to generate a combined image.

10. The method of claim 9, further comprising storing the images and a plurality of electronic print frames.

11. The method of claim 10, wherein the storing step is performed using a storage unit.

12. The method of claim 11, wherein the storage unit is a removable memory card or a static random access memory.

13. The method of claim 9, further comprising generating a viewable preview of the combination image.

14. The method of claim 13, wherein the view is displayed on a display unit.

15. The method of claim 9, wherein the steps are performed via an input unit.

16. The method of claim 9, wherein the transition format is YCrCb format, where Y represents the luminance component of the image, and Cb and Cr represent the blue-difference and red-difference chrominance components of the image, respectively.

17. The method of claim 9, further comprising framing a predetermined number of the images in a unique layout.
